(19) United States
(12) Patent Application Publication
(10) Pub. No.: US 2005/0132118 A1
(43) Pub. Date: Jun. 16, 2005

(54) System and a method for adapting an AGP-interfaced apparatus to a PCI controller

(75) Inventors: Yu-Kuang Chen, Taipei (TW); Ying-Chun Tseng, Taipei (TW)

Correspondence Address: BIRCH STEWART KOLASCH & BIRCH, PO BOX 747, FALLS CHURCH, VA, 22040-0747, US

(73) Assignee: ASROCK INCORPORATION

(21) Appl. No.: 11/007,197

(22) Filed: Dec. 9, 2004

(30) Foreign Application Priority Data
Dec. 10, 2003 (TW) 92134886

(51) Int. Cl. G06F 13/36

(52) U.S. Cl. 710/315; 710/306; 710/313

(57) ABSTRACT

A system having a mother board with a PCI controller and an AGP connector formed thereon is provided. Part of the electric contacts within the AGP connector is connected to the PCI controller and the rest contacts are opened.

### BACKGROUND OF THE INVENTION

(1) Field of the Invention

The present invention relates to a system for adapting an accelerated graphic port (AGP) interfaced apparatus to a periphery component interconnect (PCI) controller and a method for adapting the same, and more particularly relates to a system that adapts an AGP-interfaced apparatus to a PCI controller by connecting an AGP connector to a PCI controller directly and a method for adapting the same.

(2) Description of Related Art

A computer system typically includes a mother board with a system bus formed thereon as a basic component. Various devices such as a central processing unit (CPU), a chipset, and memories adapted on the mother board are communicated with each other. The chipset plays a role of ruling signal and data transmission on the system bus and periphery buses. The choice of particular chipset is according to the CPU. In addition, there should be various connectors attending with such periphery buses for connecting periphery components such as displaying cards, hard disks, soft disks, CDROMs, etc.

Referring to FIG. 1, there is a prior art mother board with a Southbridge (SB) 200 and a Northbridge (NB) 100. The NB 100 deals with data and signal transmission between a CPU 120, a main memory 140, and an AGP connector 160. The NB 100 also communicates with the SB 200 by using a particular transmission protocol. The SB 200 has a PCI controller, an IDE controller, a USB controller, and other specific controllers for controlling various periphery components 220, 240, 260, 280, so that the SB 200 is capable of dealing with input/output (I/O) signals from the periphery components 220, 240, 260, 280. Furthermore, the SB 200 also transmits interrupt requests from the periphery components 220, 240, 260, 280 to the NB 100 to ask the CPU 120 to arrange a proper operation schedule to deal with the periphery components 220, 240, 260, 280.

An AGP interface standard is developed to reduce the load of the PCI interface because of the need of a huge datastream resulted by texture mapping technique solely for 3D image, and it is based on a set of performance extensions and enhancements to the PCI interface. Referring to Table 1, the distinctions of the AGP interface and the PCI interface, such as the dimension of the connectors and the way of data transmission, are described.

TABLE 1

| Interface | AGP | PCI |
|---|---|---|
| Speed | 32 Bits | 32 Bits |
| Frequency | 66 Mhz | 33/66 Mhz |
| Number of contacts | 132 (dual layer 4×), 124 | 120 (single layer) |
| | (dual layer 8×) | |
| Data Transmission | Pipelined | Non-pipelined |
| Address/Data transmission | Address/Data | Address/Data |
| | de-multiplexing | multiplexing |
| Data-stream Speed | 1066 MB/S (4×) | 133 MB/S |
| | 2133 MB/S (8×) | (33 MHz) |

The specifications and advantages of the AGP interface are: 1) pipelined memory read and write operations, 2) de-multiplexing of address and data on the AGP bus by use of sideband signals, and 3) data transfer rates of 133 MHz for data throughput in excess of 500 MB/S. The AGP specification is neither meant to replace nor diminish full use of the PCI interface in the computer standard.

As mentioned, the AGP interface provides an independent and additional high-speed bus other than the PCI interface, through which the AGP interface is led to be one of the mainstreams in displaying card industry. However, some chipset manufacturers, such as Intel, still provide low-ended NB chips, such as 854 GVs, which don't support the AGP interface. Therefore, some old fashion PCBs that don't support the AGP interface, or some new designed PCBs that include NB chips but don't support the AGP interface are still alive, but encounter a circumstance of no compatible displaying card of PCI interface available. Moreover, in a need to assemble a computer system with two displaying cards to support two displaying equipments, a traditional PCB comprising only one AGP connector still needs a second displaying card of PCI interface. Yet, such a PCB still meets the problem of no compatible PCI displaying card available.

As shown in FIG. 2, a prior art AGP/PCI adapter 20 acts as a bridge between an AGP interfaced apparatus 30 and a PCI connector 12. A lower side of the AGP/PCI adapter 20 has PCI fingers 22, and an upper side has an AGP connector 24. The PCI fingers 22 are inserted into the PCI connector 12 on the mother board 10, and the AGP connector 24 at the upper side accepts the AGP interfaced apparatus 30 with AGP fingers.

As shown in FIG. 3A, when the AGP interfaced apparatus 30 is accepted by an AGP connector 14 formed on the mother board 10, in/out ports of the AGP interfaced apparatus 30 definitely match the openings on a back plate of the PC housing 40, and also the AGP interfaced apparatus 30 can be screw-fixed thereto.

Whereas, as shown in FIG. 3B, when the AGP/PCI adapter 20 is inserted between a PCI connector 12 on the mother board 10 and the AGP interfaced apparatus 30, the AGP interfaced apparatus 30 must be moved upward, and thus the thread holes 32 on the AGP interfaced apparatus 30 cannot match the respective thread hole 42 anymore on the PC housing 40. It is easy to see in FIG. 3B that an adapting and fixing problem is inevitable.

### SUMMARY OF THE INVENTION

It is therefore an object of the present invention to provide a computer system adapting an AGP interfaced apparatus to a PCI connector formed on a mother board.

It is a further object of the present invention to provide a mother board, which is able to adapt an AGP interface to a PCI controller so as to solve the compatible problem of the PCI displaying card.

It is another object of the present invention to provide an adapting method for solving the mismatch problem between the AGP interfaced apparatus and the PC housing when an AGP/PCI adapter is used.

The mother board of the present invention comprises a PCI controller and an AGP connector. The PCI controller can be an independent IC or situated in an NB or a SB. Part of the electric contacts of the AGP connector connect to the PCI controller for address and data transmission. Furthermore, the AGP connector connects to a power source for accessing a driving voltage with a voltage level in reference to that of a PCI connector.

Among all the electric contacts of the AGP connector, AGP specified contacts, which presents the distinction between the AGP interface and the PCI interface, such as a strobe, a status signal, a sideband signal, a read buffer full signal, and a write buffer full signal, are all opened.

The method of adopting an AGP interfaced apparatus to a PCI controller comprises the steps of: 1) providing a mother board with a PCI controller formed thereon; 2) forming an AGP connector with contacts divided into a first group and a second group on the mother board, wherein the contacts of the second group are AGP specified contacts; 3) connecting the contacts of the first group to the PCI controller, and having the contacts of the second group contacts remain opened.

Reference will now be made in detail to the preferred embodiments of the present invention, examples of which are illustrated in the accompanying drawings. Wherever possible, the same reference numbers will be used throughout the drawings to refer to the same or like parts.

### BRIEF DESCRIPTION OF THE DRAWINGS

The present invention will now be specified with reference to its preferred embodiment illustrated in the drawings, in which:

FIG. 1 depicts a schematic view of a typical mother board with a chipset including a Southbridge (SB) and a Northbridge (NB) thereon;

FIG. 2 depicts a schematic view of adapting an AGP apparatus to a PCI interface by using a traditional AGP/PCI adapter;

FIG. 3A depicts a schematic view of plugging an AGP displaying card into an AGP connector with the displaying card screw-fixed to the PC housing;

FIG. 3B depicts a schematic view of plugging an AGP displaying card into a PCI connector by using a traditional AGP/PCI adapter;

FIG. 4A depicts a schematic view of a preferred embodiment of the mother board in accordance with the present invention for adapting an AGP apparatus to a PCI controller;

FIG. 4B depicts a schematic view of another embodiment of the mother board in accordance with the present invention for adapting an AGP apparatus to a PCI controller;

FIG. 4C depicts a schematic view of the other embodiment of the mother board in accordance with the present invention for adapting an AGP apparatus to a PCI controller;

FIG. 5 shows a description of contacts in a conventional AGP connector;

FIG. 6 shows a description of contacts in a conventional PCI connector;

FIG. 7 shows a description of contacts in an AGP connector in accordance with the present invention;

FIG. 8 depicts a flowchart of a preferred embodiment for adapting an AGP interfaced apparatus to a PCI controller in accordance with the present invention;

FIG. 9 depicts a schematic view of a preferred embodiment of a computer system in accordance with the present invention;

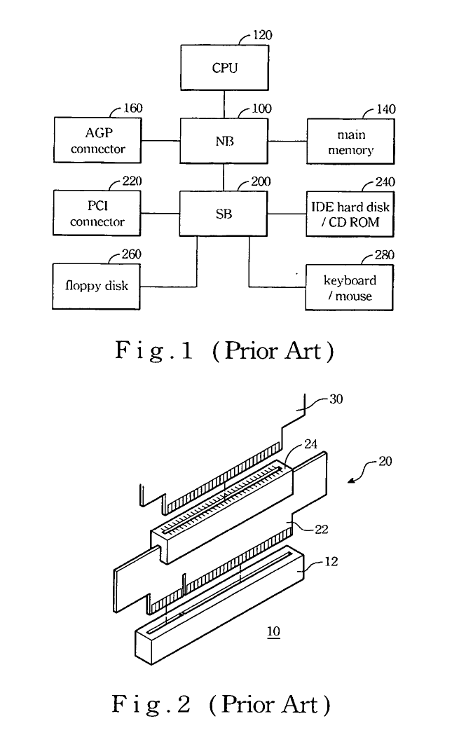

Table 1 presents the difference between a typical AGP interface and a typical PCI interface;

Table 2 describes the contacts of an AGP connector in accordance with the present invention, which shows characteristics of the AGP transmission; and

Table 3 describes the opened contacts in the AGP connector in accordance with the present invention.

### DETAIL DESCRIPTION OF THE PREFERRED EMBODIMENTS

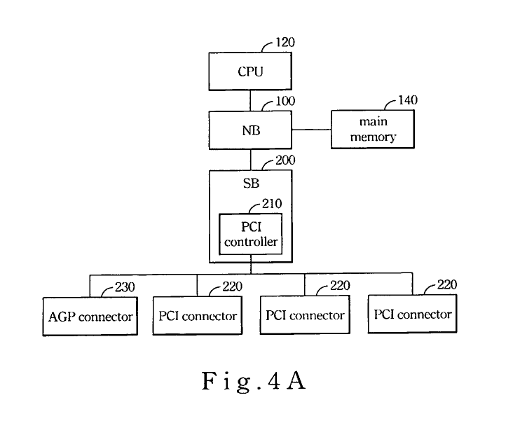

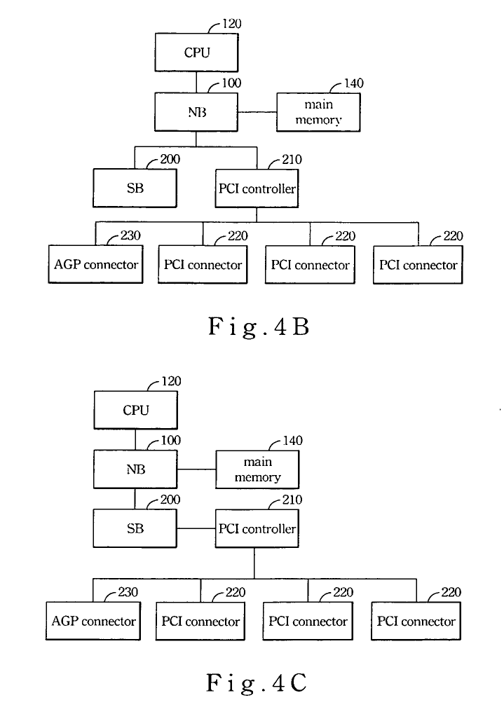

FIG. 4A shows a preferred embodiment of a mother board for adapting an AGP interfaced apparatus to a PCI controller, in which the mother board comprises a central processing unit (CPU) 120, a Northbridge (NB) 100, a Southbridge (SB) 200, an AGP connector 230, and at least a PCI connector 220 (three shown in the embodiment). The NB 100 deals with data and signal transmission between the CPU 120 and main memory 140, and it also communicates with the SB 200 through a PCI bus (not shown in the figure). A PCI controller 210 is provided in the SB 200 for forming connections with both the AGP connector 230 and the PCI connectors 220.

The PCI controller 210 may be provided in the NB 100 or in an independent IC other than SB 200 or NB 100 if necessary. As an independent IC, the PCI controller 210, which forms a connection with the AGP connector 230, may communicate with the SB 200 directly as shown in FIG. 4B, or communicate with the NB 100 directly as shown in FIG. 4C.

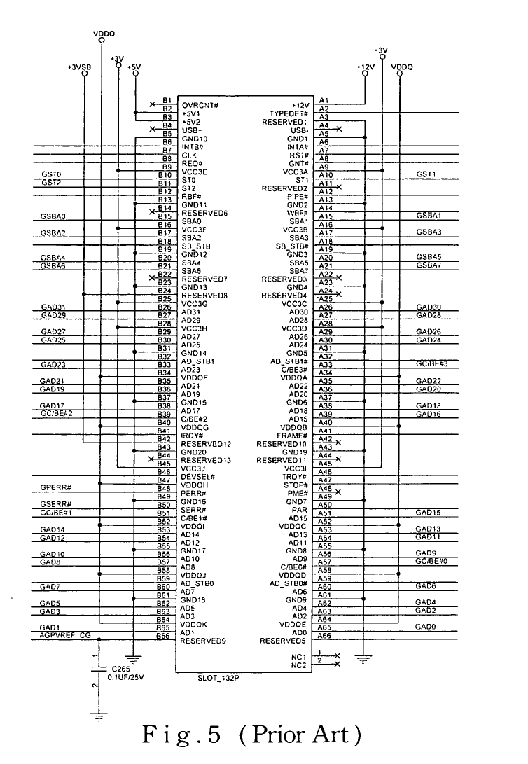

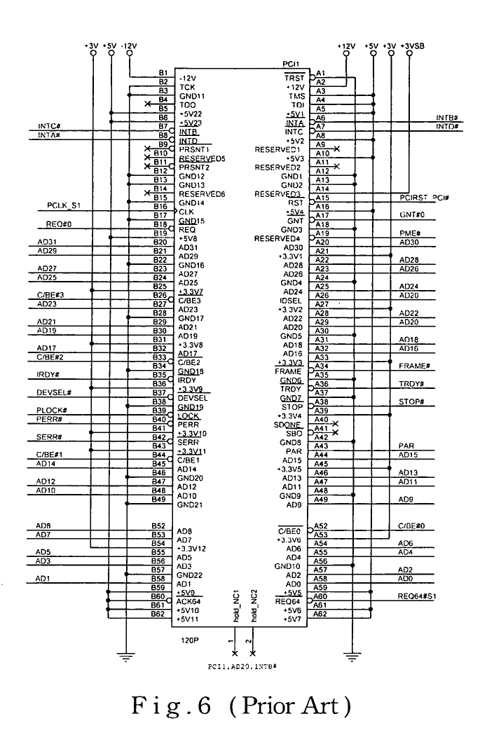

By comparing the electric contacts within a conventional AGP connector shown in FIG. 5 and that within a conventional PCI connector shown in FIG. 6, it is noted that every contact within the PCI connector has a respective contact within the AGP connector. Moreover, the AGP connector has twenty more contacts for presenting AGP character, which are described in groups in Table 2.

TABLE 2
AGP Sideband Address Signal

| | |
|---|---|
| PIPE# | Pipelined Read: providing an AGP characterized pipelined |
| | data transmission. |
| SBA[7:0] | Sideband Address: providing connections for transmission |
| | Address and Command. |

AGP Data-stream Controlling Signal

| | |
|---|---|
| RBF# | Read Buffer Full: announcing AGP controller that the |
| | plugged AGP displaying card is full and no data is |
| | accessible. |
| WBF# | Write Buffer Full: announcing the plugged AGP displaying |
| | card that the AGP controller is full and no data is |
| | accessible. |

AGP Status Signal

| | |
|---|---|
| ST[2:0] | Status: monitoring an operation status of the AGP |
| | displaying card. |

AGP Timing Signals

| | |
|---|---|
| ADSTB_A | AD Bus Strobe A: providing a timing control for the |
| | D/A buses. |
| ADSTB_B | AD Bus Strobe B: providing a timing control for the D/A |
| | buses also. |
| SBSTB | Sideband Strobe: providing a timing control for the |
| | Sideband Signal bus. |

As shown in Table 2, the electric contacts for presenting AGP character is separated into Sideband Addressing Signals, Data-stream Control Signals, Status Signals, and Timing Signals. The Sideband Addressing Signals are used to present multi-pipelined transmission and sideband addressing. The Timing Signals are used to control the timing of data transmission in replacement of a timer within a PCI interface. The Data-stream Control Signals and the Status Signals are used to inform the user of the operation status of the AGP interfaced apparatus, such as an AGP interfaced displaying card.

In addition, no matter an AGP connector or a PCI connector is used, a power supply for providing a driving voltage is definitely demanded. Basically, a typical AGP connector is integrated with a 1.5 V power supply or a 3.3 V power supply, while a typical PCI connector is integrated with a 3.3 V power supply or a 5 V power supply.

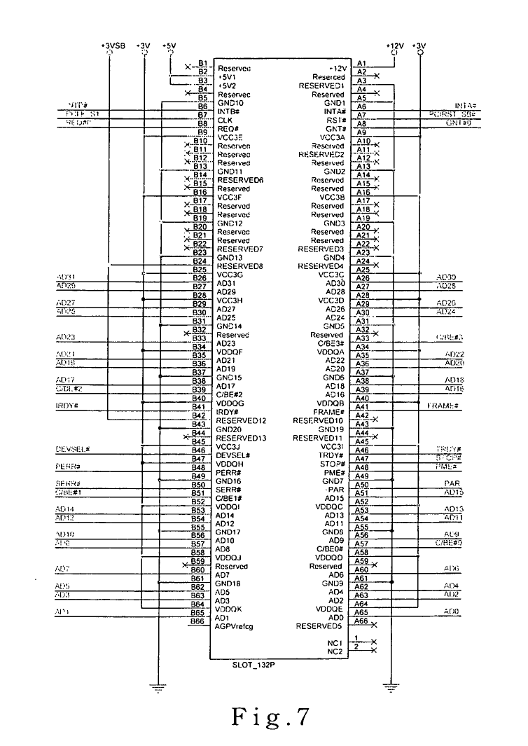

In order to adapt the AGP connector to the PCI controller without sacrificing the normal operation of the PCI controller, only part of the electric contacts (named the first group contacts) within the AGP connector of FIG. 7 are connected to the PCI controller through a typical PCI bus. The rest contacts within the AGP connector (named the second group contacts) are opened, in which these contacts as described in Table. 3 includes: 1) Address Strobe contacts, 2) Status Signal contacts, 3) Sideband Signal contacts, 4) Read Buffer Full Signal contacts, and 5) Write Buffer Full Signal contacts.

TABLE 3

| Representation | Position of Contacts |
|---|---|
| OVRCNT# | B1 |
| USB | A4, B4 |
| RESERVED | A22, B22, A24, A44, B44, A42 |
| PIPE# | A12, B14 |
| SBA[7:0] | A15, B15, A17, B17, A20, B20, A21, B21 |
| RBF# | B12 |
| WBF# | A14 |
| ST[2:0] | A10, B10, B11 |
| ADSTB | A32, B32, A59, B59 |
| SBSTB | A18, B18 |

The contacts in Table 3 is divided into two groups, originally opened contacts, such as OVRCNT#, USB, and RESERVED contacts, and AGP specified contacts, such as Address Strobe contacts, Status Signal contacts, Sideband Signal contacts, Read Buffer Full Signal contacts, and Write Buffer Full Signal contacts.

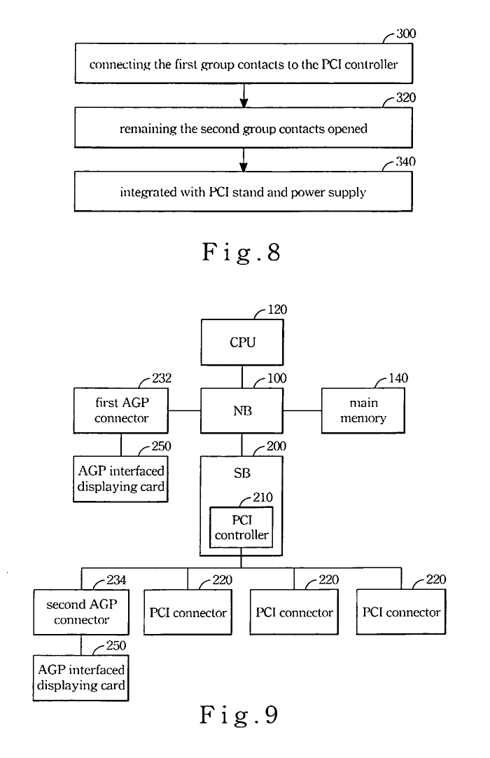

FIG. 8 shows a flowchart of a preferred embodiment for adapting an AGP interfaced apparatus to a PCI controller in accordance with the present invention. A mother board is provided with a PCI controller and an AGP connector. The AGP connector has a plurality of electric contacts divided into a first group and an AGP specified second group. In step 300, the first group contacts are connected to the PCI control through a PCI bus. Afterward, in step 320, the AGP specified second group contacts are opened. Thereafter, in step 340, because the AGP connector in accordance with the present invention is connected with a PCI controller, the AGP connector must be integrated with a PCI standard power supply for attaining a PCI standard driving voltage level.

It is noted that the electric contacts described in Table 2 are useless with respect to the PCI controller. But even connecting the electric contacts described in Table 2 to the NB, because the A/D contacts of the AGP connector in accordance with the present invention connect to the PCI controller, the NB cannot dominate the operation of the AGP connector.

FIG. 9 is a preferred embodiment of a computer system for adapting an AGP interfaced apparatus to a PCI controller. The NB 100 deals with data and signal transmission between a CPU 120, a main memory 140, and a first AGP connector 232, and it also communicates with the SB 200 through a bus. The PCI controller 210 is provided in the SB 200 and forms connections with a second AGP connector 234 and three PCI connectors 220.

As shown, the computer system is provided with two AGP connectors 232 and 234, and it is capable to adapt two AGP interfaced displaying cards 250, wherein one displaying card is communicated with the NB 100 and is operated through an AGP interface, while the other displaying card is communicated with the SB 200 and is operated through a PCI interface. Thus, the mentioned computer system is able to support two monitors by using two AGP displaying cards 250 simultaneously.

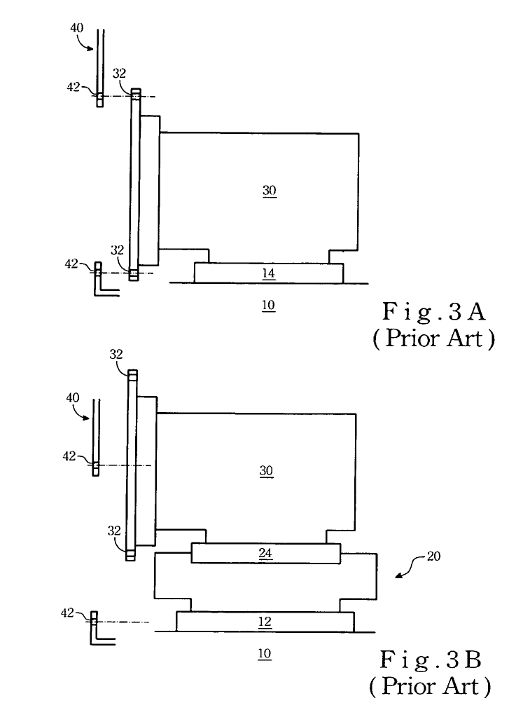

In reference to the method for adapting an AGP interfaced apparatus to a PCI controller by using an AGP/PCI adapter 20 of FIG. 3B. The method in accordance with the present invention has the following advantages:

1. In FIGS. 4A, 4B, and 4C, the mother board in accordance with the present invention has an AGP connector 230, which connects to the PCI controller 210, for accepting an AGP interfaced apparatus, such as AGP displaying card. Thus, the AGP/PCI adaptor 20 is not needed and the cost of the computer system can be reduced.

2. As mentioned, because the AGP/PCI adapter 20 is not needed in the present invention, the signal transmission distance between the AGP interfaced apparatus and the PCI controller 210 can be reduced so as to lower the signal bias rate in signal transmission and thus the operational speed can be substantially increased.

3. The AGP connector formed on the mother board for accepting the AGP interfaced apparatus in accordance with the present invention can act as a typical AGP connector. Thus, the AGP interfaced apparatus plugged into the AGP connector can be properly screw-fixed to the PC housing and the problem resulted from the usage of AGP/PCI adaptor 20 shown in FIG. 3B can be avoided.

With the example and explanations above, the features and spirits of the invention will be hopefully well described. Those skilled in the art will readily observe that numerous modifications and alterations of the device may be made when retaining the teaching of the invention. Accordingly, the above disclosure should be construed as limited only by the metes and bounds of the appended claims.

1. A mother board comprising:
a PCI controller; and
an AGP connector with a plurality of electrical contacts, parts of the contacts connecting to said PCI controller.

2. The mother board of claim 1, wherein said AGP connector is integrated with a power source of 1.5˜12V.

3. The mother board of claim 1 further comprising a southbridge thereon, and said PCI controller is formed in the south bridge.

4. The mother board of claim 1, wherein said electric contacts of said AGP connector comprise address/data (A/D) contacts.

5. The mother board of claim 4, wherein said A/D contacts of said AGP connector connect to said PCI controller.

6. The mother board of claim 1, wherein a strobe contact of said AGP connector is opened.

7. The mother board of claim 1, wherein a status signal contact of said AGP connector is opened.

8. The mother board of claim 1, wherein a sideband signal contact of said AGP connector is opened.

9. The mother board of claim 1, wherein a read buffer full (RBF) signal contact of said AGP connector is opened.

10. The mother board of claim 1, wherein a write buffer full (WBF) signal contact of said AGP connector is opened.

11. The mother board of claim 1 further comprising a PCI connector connecting to said PCI controller.

12. A system comprising:
a PCI controller;
an AGP connector with a plurality of electric contacts, parts of the contacts connecting to said PCI controller; and
an AGP-interfaced apparatus accepted by said AGP connector electrically connecting to said PCI controller through said AGP connector.

13. The system of claim 12, wherein said AGP-interfaced apparatus is an AGP-interfaced displaying card.

14. The system of claim 12, wherein said AGP connector is integrated with a power source of 1.5˜12V.

15. The system of claim 12 further comprising a south bridge therein, and said PCI controller is formed in the south bridge.

16. The system of claim 12, wherein said electric contacts of said AGP connector comprise address/data (A/D) contacts.

17. The system of claim 16, wherein said A/D contacts of said AGP connector connect to said PCI controller.

18. The system of claim 12, wherein a strobe contact of said AGP connector is opened.

19. The system of claim 12, wherein a status signal contact of said AGP connector is opened.

20. The system of claim 12, wherein a sideband signal contact of said AGP connector is opened.

21. The system of claim 12, wherein a read buffer full (RBF) signal contact of said AGP connector is opened.

22. The system of claim 12, wherein a write buffer full (WBF) signal contact of said AGP connector is opened.

23. A method for adapting an AGP-interfaced apparatus to a PCI controller comprising the steps of:
providing a mother board with the PCI controller formed thereon;
forming an AGP connector on said mother board; and
connecting parts of electric contacts within said AGP connector to said PCI controller.

24. The method of claim 23 further comprising a step of integrating said AGP connector with a power source of 1.5˜12V.

25. The method of claim 23, wherein a Strobe contact, a Status signal contact, a Sideband signal contact, a read buffer full (RBF) signal contact, and a write buffer full (WBF) signal contact of said AGP connector are opened.

26. A mother board comprising:
a PCI controller; and
an AGP connector with a plurality of electric contacts divided into a first group and an AGP specified second group, wherein said electric contacts of said first group are connected to said PCI connector and said electric contacts of said second group are opened.

27. A method for adapting an AGP-interfaced apparatus to a PCI controller comprising the steps of:
providing a mother board with the PCI controller formed thereon;
forming an AGP connector with a plurality of electric contacts divided into a first group and an AGP specified second group on said mother board; and
connecting said electric contacts of said first group to said PCI connector and remaining said electric contacts of said second group opened.
